(19) United States
(12) Patent Application Publication
(10) Pub. No.: US 2026/0021435 A1
(43) Pub. Date: Jan. 22, 2026

(54) SYSTEM AND METHOD FOR PROPANE REMOVAL IN PRE-PURIFICATION UNITS

(71) Applicants: Achintya Sujan, Tonawanda, NY (US); Matthias Grahl, Pullach (DE); Courtney E. Elwell, Tonawanda, NY (US); Cem E. Celik, Tonawanda, NY (US); Neil A. Stephenson, Tonawanda, NY (US); Philip A. Barrett, Tonawanda, NY (US)

(72) Inventors: Achintya Sujan, Tonawanda, NY (US); Matthias Grahl, Pullach (DE); Courtney E. Elwell, Tonawanda, NY (US); Cem E. Celik, Tonawanda, NY (US); Neil A. Stephenson, Tonawanda, NY (US); Philip A. Barrett, Tonawanda, NY (US)

(21) Appl. No.: 18/808,194

(22) Filed: Aug. 19, 2024

Related U.S. Application Data
(60) Provisional application No. 63/673,202, filed on Jul. 19, 2024.

(51) Int. Cl. B01D 53/04

(52) U.S. Cl. CPC B01D 53/04; B01D 2253/1085; B01D 2257/504; B01D 2257/7022; B01D 2257/80; B01D 2259/4146

(57) ABSTRACT

A system and method of propane removal in a pre-purification unit (PPU) for an air separation unit is provided. The disclosed system and method involves the use of a capping layer of zeolite exchanged with moderate amounts of barium cations, preferably a barium exchange level of 50% on an equivalent basis. This reduced or moderate level of barium exchange achieves the required propane removal but with reduced costs and reduced environmental hazards compared to prior art solutions using highly exchanged barium levels. The barium containing zeolite for the capping layer is preferably in an agglomerated form, including beads and/or pellets, having an average particle size in a range of about 1 mm to 5 mm.

### CROSS REFERENCE TO RELATED APPLICATIONS

This application claims the benefit of and priority to U.S. provisional patent application Ser. No. 63/673,202 filed on Jul. 19, 2024 the disclosure of which is incorporated by reference.

### TECHNICAL FIELD

The present system and method relates to pre-purification of air in a cryogenic air separation unit, and more particularly, the removal of contaminants such as propane and other hydrocarbons from a feed air stream using a multi-layer adsorption-based pre-purification unit.

### BACKGROUND

Insufficient removal of propane in a pre-purification unit (PPU) of an air separation unit leads to propane enrichment in the main condenser-reboiler of the distillation column system of the air separation unit. Due to the low solubility of propane in liquid oxygen, the enrichment of propane in the liquid oxygen within the main condenser-reboiler forms a potentially flammable mixture and ultimately increases the risk of a fire hazard in the presence of an ignition source. Thus, propane enrichment of the liquid oxygen in the main condenser-reboiler is a clear safety concern for air separation unit operation. Remediation of the propane enrichment in the liquid oxygen in the main condenser-reboiler condenser of an air separation unit often requires draining of the liquid oxygen from the main condenser-reboiler, which in turn, causes loss of valuable oxygen product, loss of refrigeration from the air separation unit, and increase in operating costs of the air separation unit, including power costs.

To avoid or minimize propane enrichment in the liquid oxygen within the main condenser-reboiler of the distillation column system, improved propane removal in the PPU of the air separation unit is desired. As a result, high propane removal is an important design criteria for PPUs of air separation units to minimize this safety hazard and economic losses resulting from propane enrichment in the main condenser-reboiler. Conventional PPU designs typically use an increased layer of sodium-exchanged zeolite X to remove propane in addition to removing carbon dioxide from the incoming feed air stream. It is well known that sodium-exchanged zeolite has the capacity to adsorb propane, but such removal increases the size of the adsorbent bed and the overall capital and operating costs of the PPU.

Alternative prior art solutions have also considered use of a different adsorbent that has higher capacity for propane removal than a sodium-exchanged zeolite. For example, U.S. Pat. No. 6,425,937 discloses a sodium-exchanged zeolite adsorbent having at least 70%, and more preferably at least 89%, of the cations as barium cations. Likewise, U.S. Pat. No. 7,011,695 discloses another sodium-exchanged zeolite adsorbent having up to 90% of the exchanged cations as either barium cations or calcium cations and a total of at least 40% of the exchanged cations as barium and/or calcium.

In both of the above-identified prior art documents, the objective of the calcium and/or barium exchange in the adsorbent is to delay other contaminant breakthroughs such as nitrous oxide, propane, and ethylene so that carbon dioxide is the leading indicator of contaminant breakthrough. This objective requires an excessive amount of barium-exchanged or calcium-barium-exchanged zeolite X to fully remove the nitrous oxide, propane, and ethylene.

A clear disadvantage of using such highly exchanged barium zeolite and/or calcium-barium exchanged zeolite is the increased costs associated with high barium levels in the adsorbent as well as environmental and safety hazards associated with disposal of waste adsorbent and/or the undesired leaching of barium ions from the zeolite. Replacing the sodium-exchanged zeolite bed with a highly exchanged barium or barium-calcium exchanged zeolite is not always necessary, as some level of propane breakthrough is acceptable in most PPU designs.

Thus, there is a continuing need to improve propane removal in PPUs of an air separation unit that reduces the amount of barium in the adsorbents and minimizes the size of the adsorbent beds in the PPUs.

### SUMMARY OF THE INVENTION

The present invention may be characterized as a pre-purification unit for an air-separation unit comprising: (i) a pre-purification vessel having an inlet configured for receiving a stream of feed air and an outlet configured to direct a purified air stream free of water, carbon dioxide, and substantially reduced levels of propane to the air separation unit; (ii) a first adsorbent layer disposed in the pre-purification vessel and configured to remove water from the stream of feed air and yield a first intermediate effluent; (iii) a second adsorbent layer disposed in the pre-purification vessel adjacent to the first adsorbent layer and configured to remove carbon dioxide from the first intermediate effluent and yield a second intermediate effluent; and (iv) a third adsorbent layer disposed in the pre-purification vessel adjacent to the second adsorbent layer and configured to remove propane from the second intermediate effluent. The third adsorbent layer is a barium-exchanged zeolite capping layer with a barium exchange level preferably in a range of 10% barium to 50% barium on an equivalent basis.

Alternatively, the present invention may be characterized as a method of purifying a feed air stream to reduce the propane impurities present in the feed stream, the method comprising the steps of: (a) passing the feed stream through a first adsorbent layer of a pre-purification unit configured to remove water from the feed air stream and yield a first intermediate effluent; (b) passing the first intermediate effluent through a second adsorbent layer configured to remove carbon dioxide from the first intermediate effluent and yield a second intermediate effluent; and (c) passing the second intermediate effluent through a barium-exchanged zeolite capping layer configured to remove propane from the second intermediate effluent and yield a purified air stream free of water, carbon dioxide, and with substantially reduced levels of propane. Again, the barium-exchanged zeolite capping layer has a barium exchange level in a range of 10% barium to 50% barium on an equivalent basis.

In some embodiments of the present system and method, the barium-exchanged zeolite capping layer has a SiO₂ to Al₂O₃ ratio of about 3.0 or less and is comprised of agglomerated particles of said adsorbent having average particle size in the range of about 1.0 mm to 5.0 mm, and more preferably, an average particle size in a range of about 2.0 mm to about 4.0 mm. The particle size of said agglomerated adsorbent is determined methods, familiar to those skilled in the art. For pelleted or extruded agglomerated materials, the particle size is determined by the die aperture used during manufacturing. As a result, the pellet or extrudate diameter is used to define the particle size. This can be measured by calipers or other such similar methods. For beaded or granular materials, a screen analysis, can be performed to obtain the average particle size. Other instrumentation which can be configured to provide equivalent results, such as dynamic image analysis methods, may also be used. Methods to determine the SiO₂ to Al₂O₃ ratio and barium exchange level are also known to those skilled in the art. Suitable methods include, inductively coupled plasma spectroscopy and energy dispersive spectroscopy.

Also, in some embodiments both the second adsorption layer and the third adsorption layer comprise materials that are selected from zeolite types LTA, FAU or mixtures thereof. In various preferred embodiments, the first adsorbent layer is activated alumina while the second adsorbent layer is zeolite NaX.

### BRIEF DESCRIPTION OF DRAWINGS

It is believed that the claimed invention will be better understood when taken in connection with the accompanying drawings in which:

FIG. 1 shows a general comparative representation of adsorbent bed layering schemes, including a prior art adsorbent bed layering scheme without enhanced propane removal (i.e., FIG. 1a), a prior art adsorbent bed layering scheme with an additional layer or amount of sodium X zeolite for enhanced propane removal (i.e., FIG. 1b), and an adsorbent bed layering scheme with enhanced propane removal in accordance with an embodiment of the present system and method (i.e., FIG. 1c); and

FIG. 2 shows a graphical representation of propane breakthrough curves for the three adsorbent bed layering schemes depicted in FIG. 1, as measured at a temperature of about 30° C., a pressure of about 9.0 bar (a) and with a concentration of about 1 ppm of propane in air at the inlet of each of the three adsorbent bed layering schemes depicted in FIG. 1.

### DETAILED DESCRIPTION

The present system and method embodies a process for removing gaseous impurities from a feed gas stream such as air and is targeted for applications where the purified stream is subsequently introduced into a cryogenic distillation column such as those used in air separation units. The disclosed pre-purification process comprises an adsorption based process for removing water, carbon dioxide as well as other impurities including propane from the feed gas.

The preferred process comprises passing a feed gas containing these impurities through a multi-layer pre-purification section of the pre-purification unit or vessel that is characterized as comprising at least three layers arranged in an adjacent manner such that the feed gas to be purified flows sequentially from the first layer to the second layer, and then to the third layer of the pre-purification section. It is understood that the arrangement of at least three layers may be oriented such that the flow is in an axial orientation of the pre-purification vessel or may be oriented such that the flow is in a radial direction within the pre-purification vessel. Moreover, it is also contemplated that the pre-purification unit may include other adsorption or catalyst based pre-purification sections for removing other contaminants such as hydrogen and carbon monoxide.

It is also understood that pre-purification unit may include two or more pre-purification vessels in which at least one of the pre-purification vessels is used for pre-purification service removing impurities from the feed gas while at least one other pre-purification vessel is being regenerated, preferably with a purge or regeneration gas stream. The beds switch between pre-purification service and regeneration service periodically.

The first layer of the pre-purification section may be comprised of a molecular sieve or adsorbent such as activated alumina. The second layer of the pre-purification section is preferably comprised of an adsorbent such as an X type zeolite such as NaX zeolite but other zeolites, including LTA and FAU or mixtures thereof, may also be used. When referring to X type zeolites, one skilled in the art will understand that this term includes those that belong to the zeolite X family, including zeolite X, zeolite MSX, zeolite LSX and mixtures thereof. The third layer of the pre-purification section is a barium-exchanged zeolite capping layer comprising zeolite having a SiO₂ to Al₂O₃ ratio of about 3.0 or less, and ion exchanged with a barium exchange level in a range of 10% barium to 50% barium on an equivalent basis.

The barium-exchanged zeolite capping layer achieves the desired propane removal from the feed gas over a wide range of feed gas temperatures. An exemplary barium-exchanged zeolite capping layer is zeolite X, exchanged with 48% barium on an equivalent basis and wherein the residual counter-cations are substantially sodium. Again, other materials including zeolite types LTA, FAU or mixtures thereof, may be used. The adsorbent within the barium-exchanged zeolite capping layer is preferably shaped into agglomerated particles having average particle size in the range of about 1.0 mm to about 5.0 mm, and more preferably in the range of 2.0 mm to 4.0 mm. Reduced particle size of the adsorbent within the barium-exchanged zeolite capping layer achieves faster propane adsorption kinetics.

The pre-purification unit is configured to operate at the usual gas flows applicable for air separation units and well-known pressures employed for pre-purification of air in such air separation units, generally in the range of about 0.2 bar (a) and about 25.0 bar (a) during regeneration and/or purification steps. Likewise, the present system and method are designed to operate at temperatures that range from about 5° C. to about 55° C. for the purification steps and temperatures as high as 200° C. for any regeneration steps.

As is well known in the art, air pre-purification systems use two or more pre-purification units or vessels so as to allow continuous production of purified air. When one or more of the pre-purification units is purifying the feed air, one or more other pre-purification units are being regenerated, preferably using a process widely known as thermal and/or pressure swing regeneration. The thermal regeneration process acts to desorb the water, carbon dioxide and other contaminants, such as hydrocarbons and nitrous oxide, from various layers in the pre-purification units while also restoring the hydrogen and carbon monoxide removal capacity of the hopcalite catalyst layers and other catalyst layers.

Thermal regeneration is preferably done using a multi-step process that often involves the following four steps: (i) depressurizing the vessel to lower pressures suitable for regeneration; (ii) heating the layers within the vessel to desorb the water, carbon dioxide and other contaminants from various layers; (iii) cooling the layers within the vessel back to temperatures suitable for the purification process; and (iv) repressurizing the vessel back to the higher operating pressures required for the purification process. While thermal regeneration is preferred, it is contemplated that the present system and methods could be used with pressure swing adsorption based pre-purifications or even hybrid type pre-purifications.

Thermal regeneration is preferably conducted at lower pressures such as 1.0 to 1.5 bar (a) compared to the purification process and must be conducted at temperatures of typically 150° C., and more preferably at temperatures of about 190° C., or more, subject to appropriate safety requirements. The heating step in the thermal regeneration process is typically conducted by heating a purge gas to produce a stream of hot purge gas which is fed to the vessel being regenerated via an outlet and which traverses the layers of the pre-purification unit or pre-purification section in reverse order compared to the above-described purification process. In many applications, the purge gas may be taken as a portion of the product gas or from waste gas from the distillation columns of the air separation unit. As the hot purge gas passes through the various sections and layers of the pre-purification section, the adsorbent layers are regenerated. The effluent purge gas exiting the pre-purification unit is typically vented. After the adsorbent layers are heated and regenerated, the pre-purification unit is then cooled using a cool purge gas generally at a temperature from about 10° C. up to about 50° C. that flows through the pre-purification unit in the same direction as the hot purge gas. After cooling, the pre-purification vessel is repressurized to the higher operating pressures required by the purification process.

The regeneration steps are conducted as described for a predetermined period of time, typically referred to as the cycle time after which the service or functions of the pre-purification units are switched so that vessels previously regenerating come ‘on-line’ and initiates the purification process while vessels previously purifying the feed air go ‘off-line’ and initiate the regeneration process. Typical pre-purification cycle times for air separation units is between about 180 minutes and about 480 minutes. In this manner, each pre-purification unit alternates between purification service and regeneration service to maintain continuous production of purified air substantially free of carbon dioxide, water, and other impurities.

### Comparative Examples

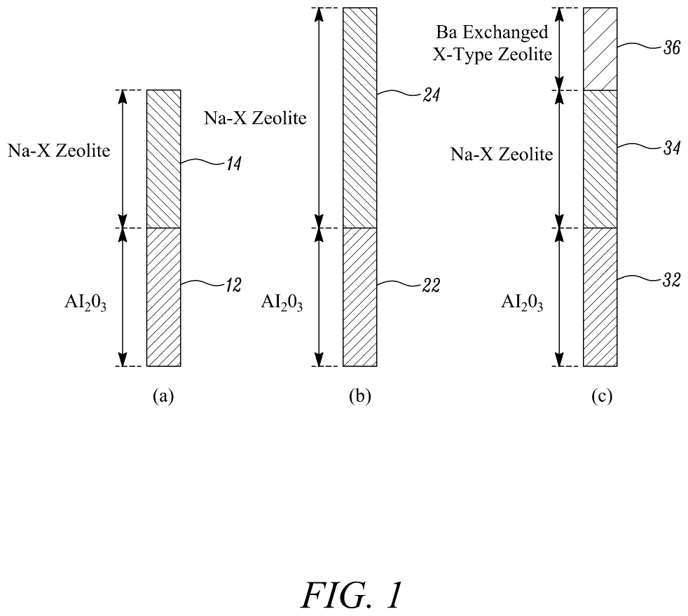

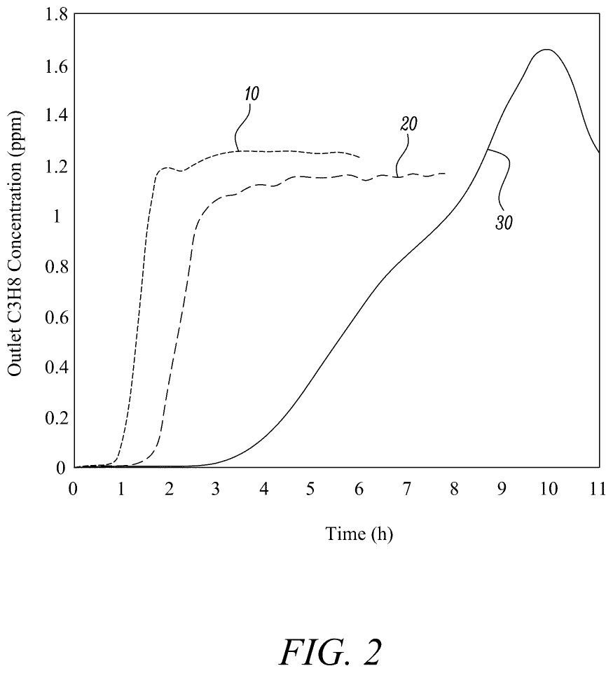

Tuning now to the drawings. FIG. 1 shows a general comparative representation of adsorbent bed layering schemes, including: (1) a prior art adsorbent bed layering scheme without enhanced propane removal depicted as bar (a); (2) a prior art adsorbent bed layering scheme with an additional layer or amount of sodium X zeolite for enhanced propane removal depicted as bar (b); and (3) an adsorbent bed layering scheme with enhanced propane removal using a barium-exchanged zeolite capping layer depicted as bar (c). FIG. 2 shows a graphical representation of propane breakthrough curves for the three adsorbent bed layering schemes depicted in FIG. 1, as measured at a temperature of about 30° C., a pressure of about 9.0 bar (a) and with a concentration of about 1 ppm of propane in air at the inlet of each of the three adsorbent bed layering schemes depicted in FIG. 1.

It is clear from the comparative results shown in FIG. 2 that the time to breakthrough of propane to a level of about 0.1 ppm in the three layer pre-purification section with the barium-exchanged zeolite capping layer (see curve 30) is roughly 4.0 hours whereas the time to breakthrough of propane to a level of about 0.1 ppm in the two layer pre-purification sections without the barium-exchanged zeolite capping layer is either about 1.0 hours (see curve 10) or about 1.5 hours (see curve 20). Curve 10 represents the propane breakthrough time of a conventional two layer adsorbent bed comprising a first layer consisting of activated alumina and a standard size second layer consisting of NaX zeolite. Curve 20 represents the propane breakthrough time of a two layer adsorbent bed comprising a first layer consisting of activated alumina and a larger size second layer consisting of NaX zeolite, a NaLSX zeolite, or a NaMSX zeolite or other sodium X type zeolites familiar to persons skilled in the art.

Thus, it is apparent from the above comparative examples that the three layer pre-purification section with the barium-exchanged zeolite capping layer is particularly effective for substantial removal of propane when used in a temperature swing adsorption process to purify atmospheric air. The technical and economic advantages of using the barium-exchanged zeolite capping layer over the prior art propane removal solutions include possible adsorbent bed size reduction for some applications which lowers the capital cost of the pre-purification vessels and also reduces the operating costs due to lower pressure drops and a reduced regeneration energy requirement compared to some of the prior art solutions.

The barium-exchanged zeolite capping layer feature also enables the amount of barium in the adsorbent to be lowered significantly compared to a full bed of highly exchanged barium zeolite disclosed in U.S. Pat. No. 6,425,937 and the highly exchanged barium and calcium exchanged zeolite disclosed in U.S. Pat. No. 7,011,695. This, in turn, reduces the scope and breadth of the environmental hazards associated with the highly exchanged barium zeolite disclosed in the above-identified United States Patent Nos.

While the present systems and methods have been described with reference to a preferred embodiment, it is understood that numerous additions, changes, and omissions can be made without departing from the spirit and scope of the present systems and methods as set forth in the appended claims.

What is claimed is:

1. A pre-purification unit for an air-separation unit comprising:
a pre-purification vessel having an inlet configured for receiving a stream of feed air and an outlet configured to direct a purified air stream free of water, carbon dioxide, and substantially reduced levels of propane to the air separation unit;
a first adsorbent layer disposed in the pre-purification vessel and configured to remove water from the stream of feed air and yield a first intermediate effluent;
a second adsorbent layer disposed in the pre-purification vessel adjacent to the first adsorbent layer and configured to remove carbon dioxide from the first intermediate effluent and yield a second intermediate effluent; and
a third adsorbent layer disposed in the pre-purification vessel adjacent to the second adsorbent layer and configured to substantially remove propane from the second intermediate effluent;
wherein the third adsorbent layer is a barium-exchanged zeolite capping layer with a barium exchange level in a range of 10% barium to 50% barium on an equivalent basis.

2. The pre-purification unit of claim 1, wherein the barium-exchanged zeolite capping layer has a SiO₂ to Al₂O₃ ratio of about 3.0 or less.

3. The pre-purification unit of claim 1, wherein the zeolite materials in the barium-exchanged zeolite capping layer are selected from zeolite types LTA, FAU or mixtures thereof.

4. The pre-purification unit of claim 1, wherein the second adsorbent layer comprises zeolite X, zeolite MSX, zeolite LSX and mixtures thereof.

5. The pre-purification unit of claim 1, wherein the first adsorbent layer is activated alumina and the second adsorbent layer is NaX zeolite, NaLSX zeolite, NaMSX zeolite or mixtures thereof having a SiO₂ to Al₂O₃ ratio of about 3.0 or less.

6. The pre-purification unit of claim 1, wherein the barium-exchanged zeolite capping layer comprises an adsorbent in the form of agglomerated particles having average particle size in the range of about 1.0 mm to about 5.0 mm.

7. The pre-purification unit of claim 6, wherein the average particle size of the adsorbent in the barium-exchanged zeolite capping layer is in the range of about 2.0 mm to about 4.0 mm.

8. A method of purifying a feed air stream to reduce the propane impurities present in the feed stream, the method comprising the steps of:
(a) passing the feed stream through a first adsorbent layer of a pre-purification unit configured to remove water from the feed air stream and yield a first intermediate effluent;
(b) passing the first intermediate effluent through a second adsorbent layer configured to remove carbon dioxide from the first intermediate effluent and yield a second intermediate effluent; and
(c) passing the second intermediate effluent through a barium-exchanged zeolite capping layer configured to substantially remove propane from the second intermediate effluent and yield a purified air stream free of water, carbon dioxide, and substantially reduced levels of propane;
wherein the barium-exchanged zeolite capping layer has a barium exchange level in a range of 10% barium to 50% barium on an equivalent basis.

9. The method of claim 8, wherein the barium-exchanged zeolite capping layer has a SiO₂ to Al₂O₃ ratio of about 3.0 or less.

10. The method of claim 8, wherein the zeolite materials in the barium-exchanged zeolite capping layer are selected from the zeolite types LTA, FAU or mixtures thereof.

11. The method of claim 8, wherein the second adsorbent layer comprises zeolite X, zeolite MSX, zeolite LSX and mixtures thereof.

12. The method of claim 8, wherein the first adsorbent layer is activated alumina and the second adsorbent layer is zeolite NaX, NaLSX or NaMSX having a SiO₂ to Al₂O₃ ratio of about 3.0 or less.

13. The method of claim 8, wherein the barium-exchanged zeolite capping layer comprises an adsorbent in the form of agglomerated particles having average particle size in the range of about 1.0 mm to about 5.0 mm.

14. The method of claim 13, wherein the average particle size of the adsorbent in the barium-exchanged zeolite capping layer is in the range of about 2.0 mm to about 4.0 mm.
